(19) United States
(12) Patent Application Publication
(10) Pub. No.: US 2016/0350010 A1
(43) Pub. Date: Dec. 1, 2016

(54) PROVIDING BLOCK SIZE COMPATIBILITY WITH A STORAGE FILTER

(71) Applicant: VMware, Inc., Palo Alto, CA (US)

(72) Inventors: Nick Michael Ryan, Sunnyvale, CA (US); Petr Vandrovec, Cupertino, CA (US); Asit Desai, San Ramon, CA (US)

(21) Appl. No.: 14/726,598

(22) Filed: May 31, 2015

(51) Int. Cl. G06F 3/06; G06F 9/455

(52) U.S. Cl. CPC G06F 3/0619; G06F 3/065; G06F 3/0659; G06F 9/45558; G06F 2009/45579

(57) ABSTRACT

Examples provide input and output request block size compatibility. A storage filter converts input and output (IO) requests associated with a first data block size into modified IO requests compatible with a data storage organized in a second data block size where the first data block size is different than the first data block size. The storage filter translates read IO requests for a smaller block size into modified read requests for a data storage organized with a larger data block size. Write IO requests for smaller block size are converted into modified write IO requests for larger data block size data storage. The storage filter also converts read IO requests generated for larger block size into smaller block size read IO requests. Likewise, the storage filter also translates write IO requests corresponding to larger data block size into modified write IO requests of smaller block size.

### BACKGROUND

Disk storage is organized in units of particular block size. A block size may also be referred to as a disk sector size. A commonly used block size is a 512 byte block size. Disk storage input/output (IO) requests for a disk storage utilizing the 512 byte block size includes offset and length fields that are interpreted as chunks of 512 bytes. It is likely that millions or even billions of lines of storage code have been written under the assumption that an underlying disk storage system is organized in 512 byte sectors. However, it is becoming increasingly common for disk storage systems to be organized in 4,096 byte blocks instead of 512 byte blocks. A block size of 4,096 bytes may also be referred to as a 4 k sector size or a 4 k block size.

Users of a disk storage associated with a given block size may want to access the storage using a different block size. However, storage code written for a 512 block size based storage system will not work correctly when used with a 4 k block size disk storage system. Likewise, storage code written for a 4 k block sized based storage system will not work correctly when used with a 512 block size based storage system.

In some cases, users may be able to re-write storage code to accommodate the different block size. However, this is a very complex, tedious, and time-consuming task. Moreover, in some cases, re-writing storage code is not an effective option. For example, a virtual machine (VM) installed onto a disk having a given block size cannot be easily re-written to run on a disk associated a different block size. For example, a VM installed on a 512 block size disk cannot be migrated to a new storage system having a 4 k block size.

### BRIEF DESCRIPTION OF THE DRAWINGS

FIG. 1 is a block diagram of a computing device for implementing a storage filter.

FIG. 2 is a block diagram illustrating block size translation using a storage filter.

FIG. 3 is a block diagram illustrating translation of smaller data block sizes to larger data block sizes by a storage filter for servicing read IO requests.

FIG. 4 is a block diagram illustrating reading 4096 byte block size data from a data storage device in response to a read request associated with a 512 byte block size.

FIG. 5 is a block diagram illustrating translation of larger data block sizes to smaller data block sizes by a storage filter for servicing read IO requests.

FIG. 6 is a block diagram illustrating reading data from a data storage device having a 512 byte sector size in response to a write request corresponding to a 4096 byte block size in accordance with a set of commands generated by a storage filter.

FIG. 7 is a block diagram illustrating a storage filter translating a write request for a smaller block size to a write request for a larger block size associated with a data storage device.

FIG. 8 is a block diagram illustrating writing data associated with a smaller block size to a data storage device having a larger block size in accordance with a set of commands generated by a storage filter.

FIG. 9 is a block diagram illustrating writing 512 byte block size data to a data storage device associated with a 4096 byte block size.

FIG. 10 is a block diagram illustrating writing data associated with a larger block size to a data storage device associated with a smaller block size.

FIG. 11 is a block diagram illustrating writing 4096 byte block size data to a data storage device associated with a 512 byte block size by a storage filter using a data journal.

FIG. 12 is a mapping table utilized by a storage filter for converting write requests associated with a smaller byte block size to write requests associated with a larger byte block size.

FIG. 13 is an updated mapping table utilized by a storage filter.

FIG. 14 is a flowchart of a process for converting read requests associated with a smaller block size to a larger block size by a storage filter.

FIG. 15 is a flowchart of a process for converting write requests associated with a smaller block size to a larger block size by a storage filter.

FIG. 16 is a flowchart of a process for converting write requests associated with a larger block size to a smaller block size associated with a data storage device, by a storage filter.

FIG. 17 is a block diagram of an exemplary host computing device.

FIG. 18 is a block diagram of virtual machines that are instantiated on host computing device.

Corresponding reference characters indicate corresponding parts throughout the drawings.

### DETAILED DESCRIPTION

Examples described herein allow data storage devices organized in a particular block size to be accessed by virtual machines, computing devices, or other clients using a different block size without re-writing storage code. In some examples, the storage filter converts a read IO request having a smaller block size than a storage device into a modified read IO request corresponding to the larger block size of the storage device. A block size may include any block size, including but not limited to, 512 byte block size, 1024 byte block size, 2048 byte block size, 4096 byte block size, or any other byte block size. For example, the storage filter may convert a 512 byte block size read request into a 4096 byte block size read request.

In other examples, the storage filter converts write requests having smaller block size than the storage device into a modified write IO request corresponding to the larger block size of the data storage. For example, the storage filter translates 512 byte block write requests into 4096 byte block write requests.

In yet other examples, the storage filter converts a read requests having a larger block size than the storage device into a modified read IO request corresponding to the smaller block size of the data storage. For example, the storage filter translates 4096 byte block read requests into 512 byte block read requests.

In still other examples, the storage filter converts write requests having larger block size than the storage device into a modified write IO request corresponding to the smaller data storage block size. For example, the storage filter translates 4096 byte block write requests into 512 byte block write requests.

Aspects of the disclosure enable a storage filter for block size compatibility. The storage filter converts IO requests of one block size to IO requests of a different block size without data corruption, thereby creating a reduced error rate.

Aspects of the disclosure also enable the storage filter to automatically convert IO requests of one block size to IO requests of a different size without requiring users to re-write, change, or modify storage code. This improves user efficiency and increases user performance by freeing the user from the tedious, time-consuming, and inefficient process of rewriting storage code.

The storage filter enables quick and efficient translation of 512 byte block IO requests to 4096 byte block IO requests in a timely manner. The storage filter further enables conversion of large storage libraries and is capable of handling cases in which rewriting storage code is not an option, such as migrating virtual machines installed to a 4096 byte block disk to a 512 byte block disk.

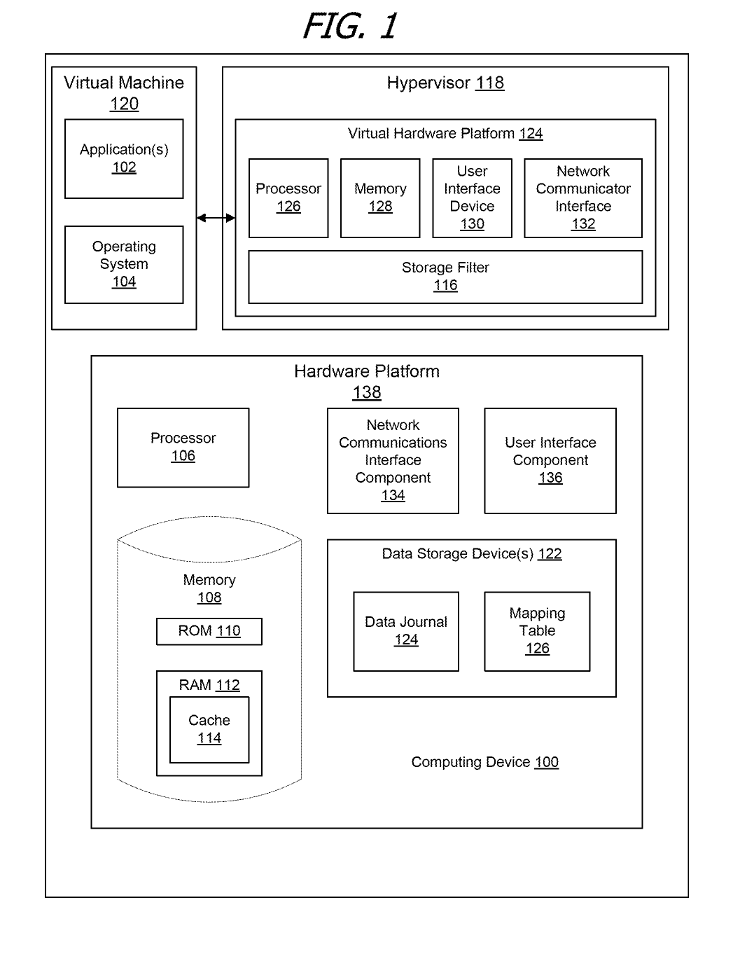

FIG. 1 is a block diagram of a computing device for implementing a storage filter. The illustrated computing device 100 may be implemented as any type of computing device. The computing device 100 represents any device executing instructions (e.g., as application(s) 102, operating system 104, operating system functionality, or both) to implement the operations and functionality associated with the computing device 100. The computing device 100 may include desktop personal computers, kiosks, tabletop devices, industrial control devices, wireless charging stations, and mobile computing devices. Additionally, the computing device 100 may represent a group of processing units or other computing devices.

The computing device 100 includes a hardware platform 138. The hardware platform 138, in some examples, includes at least one processor 106, a memory 108, and at least one user interface, such as user interface component 136.

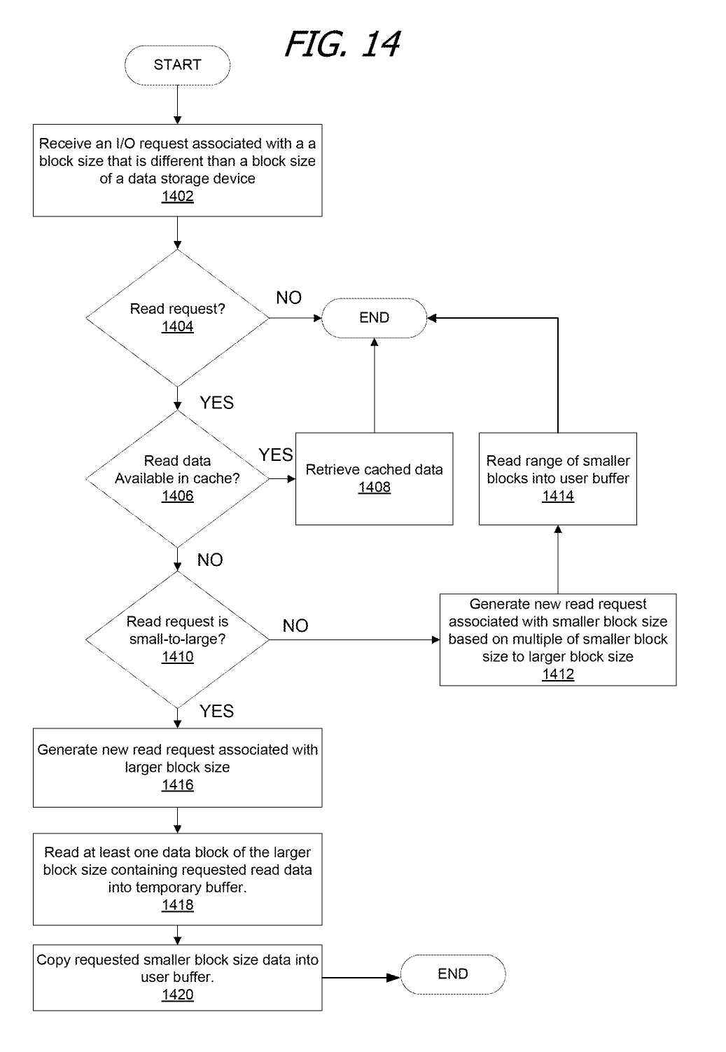

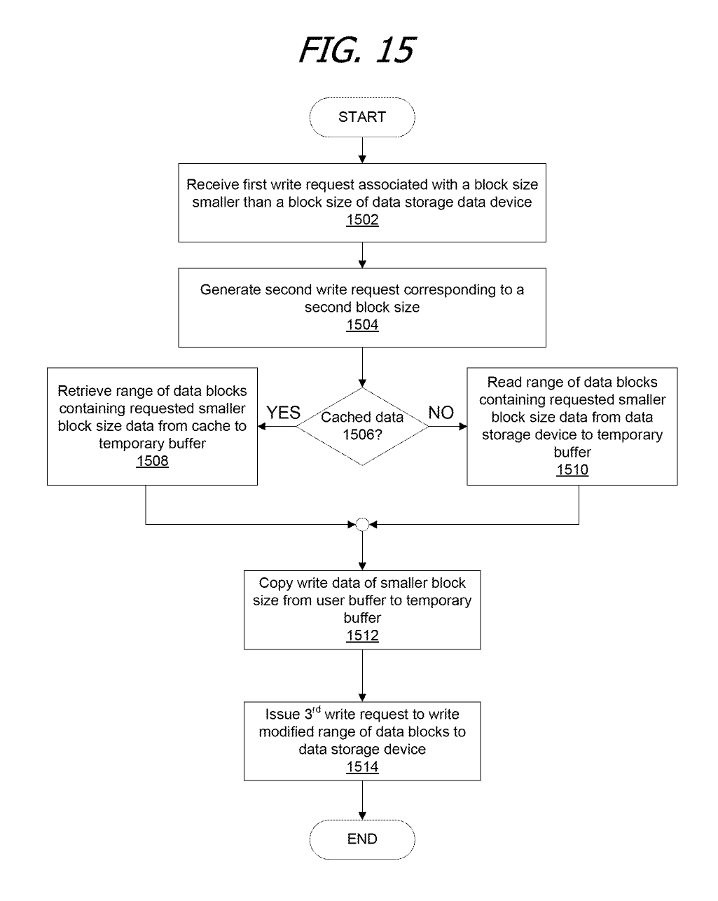

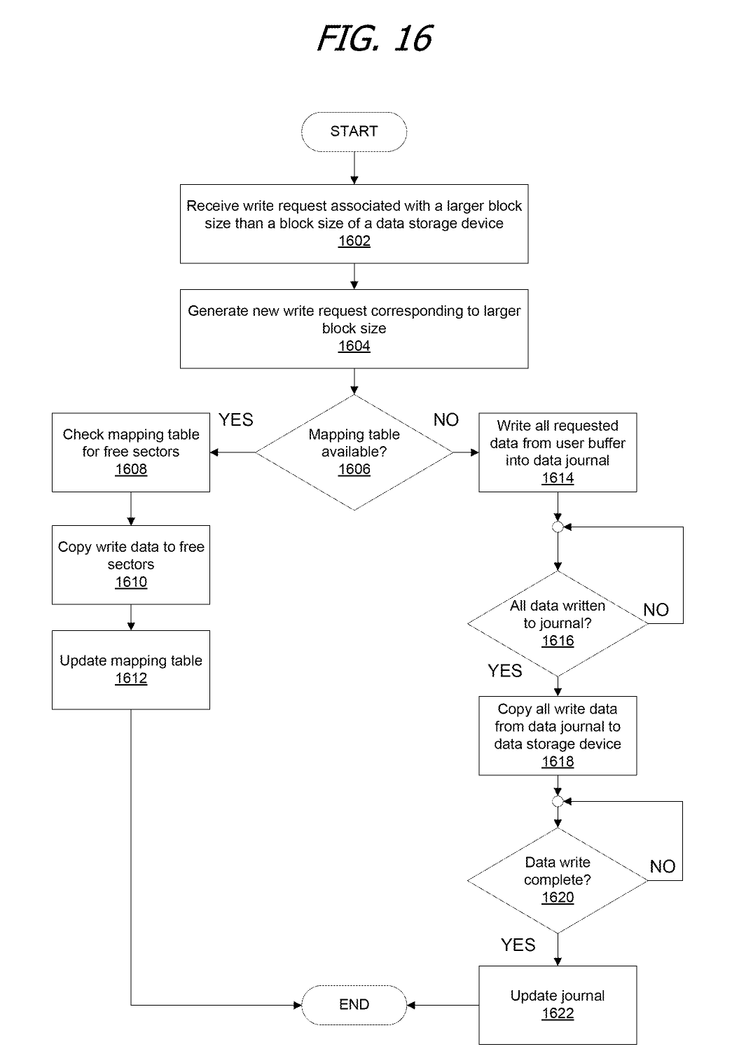

The processor 106 includes any quantity of processing units, and is programmed to execute computer-executable instructions for implementing aspects of the disclosure. The instructions may be performed by the processor or by multiple processors within the computing device 100, or performed by a processor external to the computing device 100. In some examples, the processor 106 is programmed to execute instructions such as those illustrated in the figures (e.g., FIG. 14, FIG. 15, and FIG. 16).

In some examples, the processor 106 represents an implementation of analog techniques to perform the operations described herein. For example, the operations may be performed by an analog computing device and/or a digital computing device.

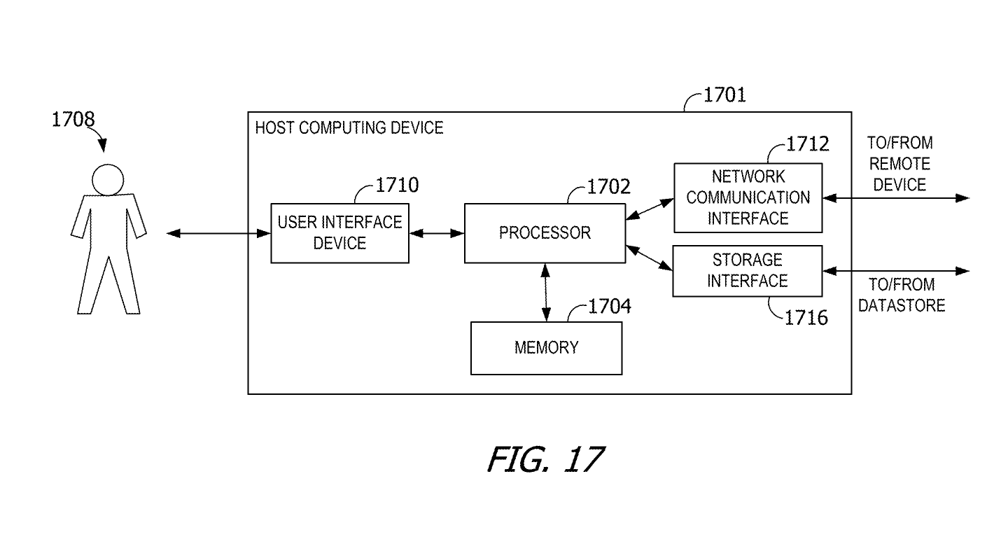

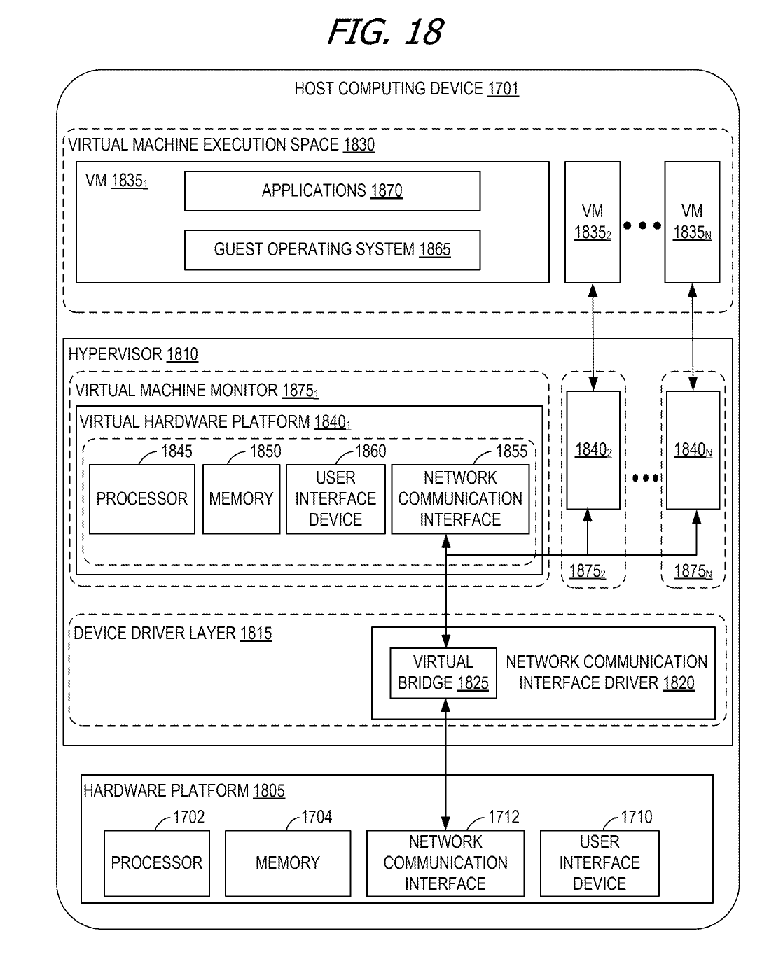

The computing device 100 further has one or more computer readable media such as the memory 108. The memory 108 includes any quantity of media associated with or accessible by the computing device 100. The memory 108 may be internal to the computing device 100 (as shown in FIG. 1, FIG. 17, and FIG. 18), external to the computing device (not shown), or both (not shown). In some examples, the memory 108 includes read-only memory (ROM) 110 and/or memory wired into an analog computing device.

The virtual machine 120 includes, among other data, one or more application(s) 102. The application(s) 102, when executed by the processor 106, operate to perform functionality on the computing device 100. Exemplary application(s) include, without limitation, mail application programs, web browsers, calendar application programs, address book application programs, messaging programs, media applications, location-based services, search programs, and the like. The application(s) 102 may communicate with counterpart applications or services such as web services accessible via a network. For example, the applications may represent downloaded client-side applications that correspond to server-side services executing in a cloud.

The memory 108 further stores a random access memory (RAM) 112. The RAM 112 may be any type of random access memory. The RAM 112 may optionally include one or more cache(s) 114.

The memory 108 further stores one or more computer-executable components. Exemplary components include a storage filter 116 component implemented on the hypervisor 118. The storage filter 116 component, when executed by the processor 106 of the computing device 100, causes the processor to convert input and output (IO) requests of a first data block size received from a client, such as virtual machine 120, into an IO request of a different data block size corresponding to the sector size of the data storage device(s) 122. For example, IO requests of a smaller data block size may be converted into an IO request of a larger block size, and vice versa.

The hypervisor 118 is a virtual machine monitor that creates and runs one or more virtual machines, such as, but without limitation, virtual machine 120. In one example, the hypervisor 118 is implemented as a vSphere Hypervisor from VMware, Inc.

The computing device 100 running the hypervisor 118 is a host machine. Virtual machine 120 is a guest machine. The hypervisor 118 presents the operating system 104 of the virtual machine 120 with a virtual hardware platform 124. The virtual hardware platform 124 may include, without limitation, virtualized processor 126, memory 128, user interface device 130, and network communication interface 132. The virtual hardware platform, virtual machine(s) and the hypervisor are illustrated and described in more detail in FIG. 18 below.

The storage filter 116 in this example is described as being implemented on a hypervisor associated with one or more virtual machines; however, the disclosure is also applicable to non-virtualized environments. For example, the storage filter 116 may be implemented on an operating system on a client computing device in a non-virtualized environment.

Likewise, the storage filter 116 in this example is shown as being implemented on a host computing device 100. However, the storage filter 116 in other examples may be implemented in a user device, a storage device, a virtual machine, a consumer operating system. The storage filter 116 may be implemented on a client side device, a back-end server side device, back-end storage side device, or any other type of computing device.

In some examples, the hardware platform 138 of computing device 100 optionally includes a network communications interface component 134. The network communications interface 134 component includes a network interface card and/or computer-executable instructions (e.g., a driver) for operating the network interface card. Communication between the computing device 100 and other devices may occur using any protocol or mechanism over any wired or wireless connection. In some examples, the communications interface is operable with short range communication technologies such as by using near-field communication (NFC) tags.

The computing device 100 may optionally include a user interface component 136. In some examples, the user interface component 136 includes a graphics card for displaying data to the user and receiving data from the user. The user interface component 136 may also include computer-executable instructions (e.g., a driver) for operating the graphics card. Further, the user interface component 136 may include a display (e.g., a touch screen display or natural user interface) and/or computer-executable instructions (e.g., a driver) for operating the display. The user interface component may also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device 100 in a particular way.

The data storage device(s) 122 may be implemented as any type of data storage, including, but without limitation, a hard disk, optical disk, a redundant array of independent disks (RAID), a solid state drive (SSD), a flash memory drive, a storage area network (SAN), or any other type of data storage device. The data storage device(s) 122 may include rotational storage, such as a disk. The data storage device(s) 122 may also include non-rotational storage media, such as SSD or flash memory.

The data storage device(s) 122 may optionally include a data journal 140. A data journal 140 is a file system that tracks changes made to the data storage device(s) 122. The storage filter 116 updates an entry in the data journal 140 during writes to a data storage device. The data journal 140 ensures write atomicity and enables accurate data recovery after a failure, such as loss of power or a systems crash occurring during a write operation. The data journal 140 may be located on the same disk or same data storage device as the disk receiving the data writes. The data journal 140 may also be located or stored on an external disk or data storage device that is separate from the disk associated with the data writes.

The data storage device(s) 122 may also include a mapping table 142. A mapping table is a persistent table maintained in data storage. The mapping table maps disk sectors that contain data and disk sectors that are free or available for new writes. The mapping table enables quick and efficient identification of free data storage sectors. The mapping table also enables identification of sectors of one block size corresponding to IO requests of a different block size.

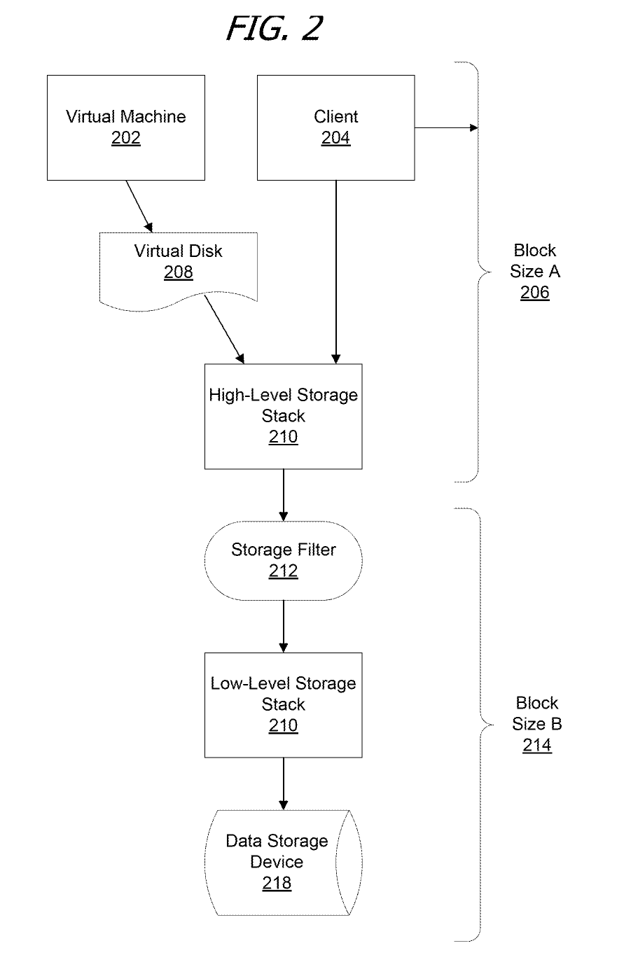

FIG. 2 is a block diagram illustrating block size translation using a storage filter. Virtual machine 202 is an emulation of a computer system, such as, but not limited to, virtual machine 120 in FIG. 1. Client 204 may be any type of computing device, such as, but not limited to, a user device. A user device may be a mobile computing device or any other portable device. In some examples, the client 204 may be a mobile telephone, laptop, tablet, computing pad, netbook, gaming device, and/or portable media player. The client 204 may also include less portable devices such as desktop personal computers, kiosks, and tabletop devices.

An IO request associated with a smaller data block size may be sent by the virtual machine 202 or by the client 204. The virtual machine 202 may transmit the IO request via virtual disk 208 through high-level storage stack 210. The virtual disk 208 may be a virtual logical disk or storage virtualization application volume.

The storage filter 212 intercepts the IO request. The storage filter 212 converts the IO request associated with one block size, such as block size A 206, to an IO request associated with a different block size, such as block size B 214. A block size is a number of bytes in sequence having a maximum length. Data is typically stored in a buffer, read from data storage, or written to data storage a block at a time. Therefore, an IO request to read data or write data to a storage device should have a block size that is the same as the block size of the storage device to perform the IO request and avoid data corruption.

The storage filter 212 automatically converts the IO request from one block size to a different block size corresponding to the data storage device 218 to form a modified IO request. The storage filter performs this conversion transparently without the need for any changes to higher-level or lower-level components in the storage stack. The storage filter 212 sends the modified IO request via the low-level storage stack 216 to the data storage device 218.

In some examples, the storage filter operates in two modes. The first mode, mode one, is for translating smaller block sizes to larger block sizes. The second mode is for translating larger block sizes to smaller block sizes.

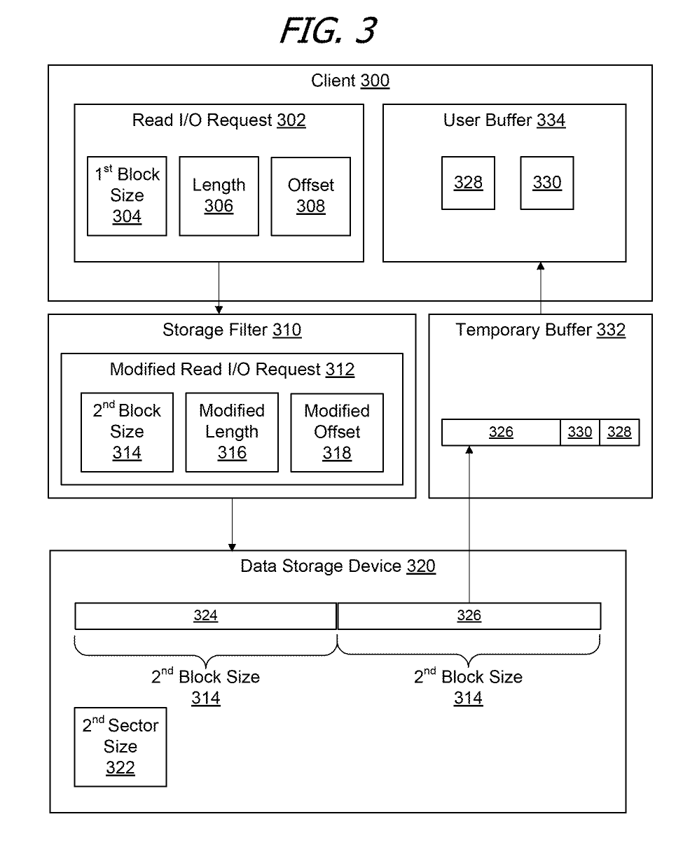

FIG. 3 is a block diagram illustrating translation of smaller data block sizes to larger data block sizes by a storage filter for servicing read IO requests. A client 300 issues a read IO request 302. The read IO request 302 is a request for data to be read in a smaller block size 304 than a block size of the data storage device 320. The smaller block size 304 may be any block size that is smaller than the block size of the data storage device 320, including but not limited to, 512 byte block size, 1024 byte block size, 2048 byte block size, 4096 byte block size, or any other byte block size.

The read IO request 302 includes a length 306 and offset 308 identifying a location of the requested read data. The length 306 and offset 308 correspond to the smaller block size 304. In other words, the length and offset are multiples of the block size. The offset and length fields are interpreted by the disk or other data storage device as multiples of the fixed, smaller block size 304. If the block size 304 is 512 bytes, the length 306 and offset 308 are multiples of the block size. The red IO request 302 may also include a pointer field for a data buffer.

The storage filter 310 converts the read IO request 302 into a modified read IO request 312 corresponding to the larger block size 314.

The data storage device block size 314 may be any block size that is larger than block size 304. The larger block size 314 may be, for example, but without limitation, a 512 byte block size, a 1024 byte block size, a 2048 byte block size, a 4096 byte block size, or any other byte block size. The modified read IO request 312 includes a modified length 316 and a modified offset 318 corresponding to the larger block size 314.

The modified read IO request 312 includes a set of small-to-large commands for performing the requested read operation. In some examples, the set of small-to-large commands includes one or more small computer system interface (SCSI) command(s).

The data storage device 320 has a sector size 322. The sector size 322 indicates the block size of the data stored in the data storage device 320. In this example, data blocks 324 and 326 are organized in the larger block size 314.

The modified read IO request is processed to read one or more data block(s) in the larger block size from the data storage device 320. The one or more data blocks containing the requested data are read from the data storage device to the temporary buffer 332. In this example, data block 326 contains the requested read data.

The requested data in the smaller block size 304 is copied from the temporary buffer 332 to the user buffer 334. In this example, the smaller blocks 328 and 330 are copied from the temporary buffer 332 to the user buffer 334. The remaining unused portion of the larger block 326 is not copied out of the temporary buffer 332. Thus, the smaller blocks 328 and 330 include the requested read data in the smaller block size 304 corresponding to the original read IO request 302.

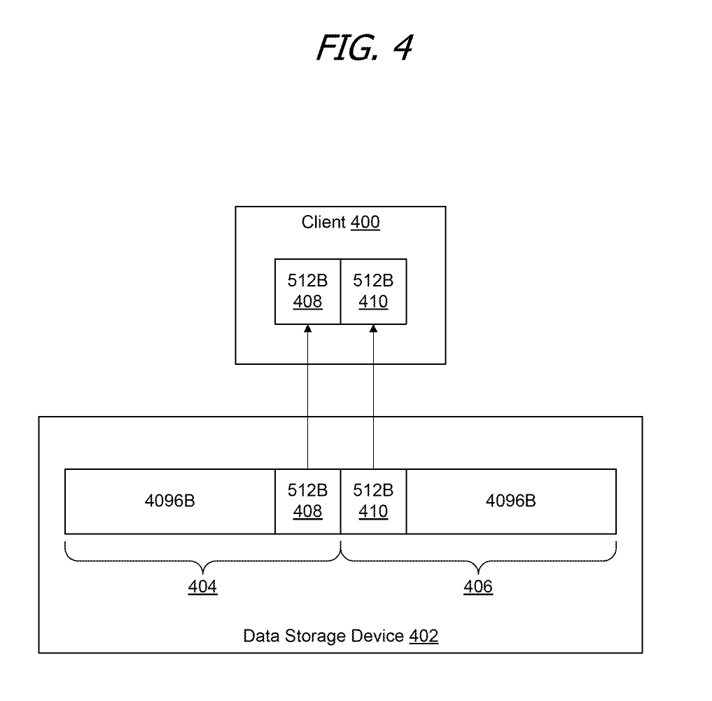

FIG. 4 is a block diagram illustrating reading 4096 byte block size data from a data storage device in response to a read request associated with a 512 byte block size. The client 400, in this example, sends an IO read request to read data having a 512 byte block size. The storage filter modifies the read IO request to correspond to the 4096 byte block size of the data storage device 402. The modified read IO request is executed to read the larger 4096 byte data blocks containing the requested data 404 and 406 into a temporary buffer. The smaller block size data 408 and 410 are copied from the temporary buffer into the user buffer for the client 400. This completes the read IO request.

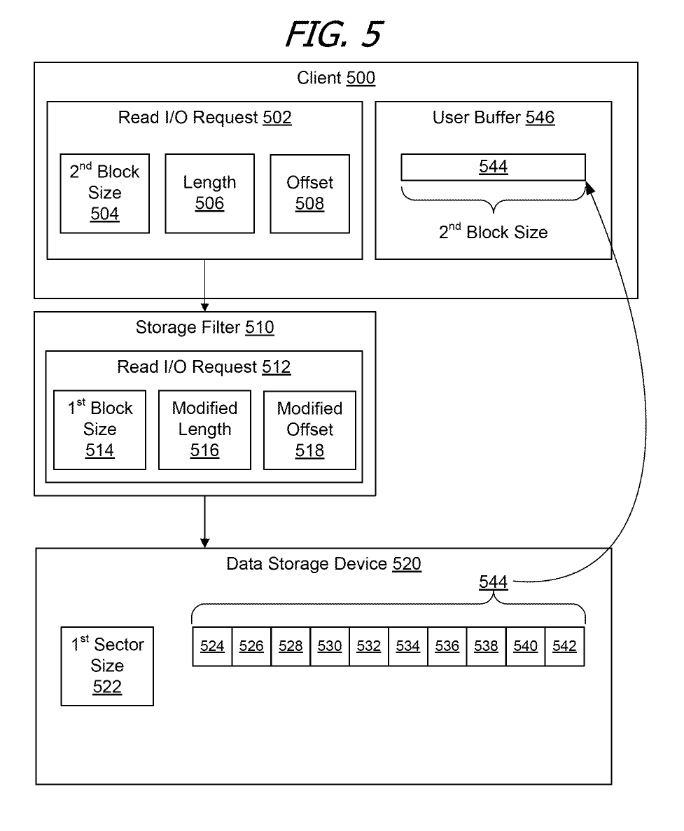

FIG. 5 is a block diagram illustrating translation of larger data block sizes to smaller data block sizes by a storage filter for servicing read IO requests. The client 500 issues a read IO request 502 associated with block size 504. The block size 504 of the read IO request 502 is a larger block size than the smaller block size 514 of the data storage device.

The read IO request 502, in this non-limiting example, includes a length 506 and offset 508. The storage filter 510 converts the read IO request 502 into a modified read IO request 548 that is associated with the smaller block size 514. The modified read IO request 548 is compatible with data storage device 520 organized in accordance with the smaller block size 514. The modified read IO request 548 may be referred to as a large-to-small read IO request.

The modified read IO request 548 also optionally includes a modified length 516 and a modified offset 518 corresponding to the smaller block size 514. The modified length 516 and modified offset 518 in some examples are calculated based on a multiple of the smaller block size 514 to the larger block size 504. For example, if the smaller block size 514 is 512 byte block size and the larger block size 504 is 4096 byte block size, the smaller block size 514 is eight (8) times smaller than the larger block size. Thus, the modified length 516 and offset 518 may be calculated based on the multiple of 8.

The block size of the data storage device 520 in this non-limiting example is based on the sector size 522. The data on the data storage device 520 is organized into sectors having a given block size. In this example, the sector size 522 indicates the block size of the data stored on the data storage device 520.

The modified read IO request 548 is processed to identify a range 544 of two or more data blocks of the smaller block size 514 on the data storage device 520 that correspond to the one or more data blocks of the larger block size 504 that is requested by the client 500 in the original read IO request 502. The range 544 of smaller data blocks is a set of two or more blocks of data. In other words, the set of two or more data blocks of the smaller block size 514 that contain the requested read data are identified.

This range 544 of smaller data blocks of block size 514 are equivalent to a data block of the larger block size 504. The range 544 of smaller data blocks are read directly into the user buffer 546 for access by the client 500. This completes the read operation.

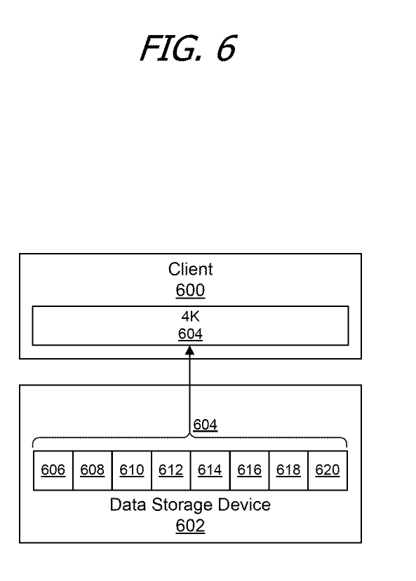

FIG. 6 is a block diagram illustrating reading data from a data storage device having a 512 byte sector size in response to a write request corresponding to a 4096 byte block size in accordance with a set of commands generated by a storage filter. In this non-limiting example, the client 600 generates an original read IO request for data having a larger 4096 (4K) block size than the smaller 512 byte block size of the data storage device 602. The storage filter intercepts the original IO request and issues a new IO request corresponding to the smaller 512 byte block size of the data storage device 602. The new IO request, which is a large-to-small read request, is executed to read a range 604 of the smaller data blocks corresponding to the requested read data that was requested by the client 600 in the original read IO request.

In this example, the range 604 of smaller block sizes includes eight (8) smaller data blocks, 606, 608, 610, 612, 614, 616, 618, and 620. This range 604 of eight smaller 512 byte data blocks corresponds to the 4096 byte read data block requested by the client 600. The range 604 of smaller data blocks is read directly from the data storage device 602 into the user buffer to complete the read operation.

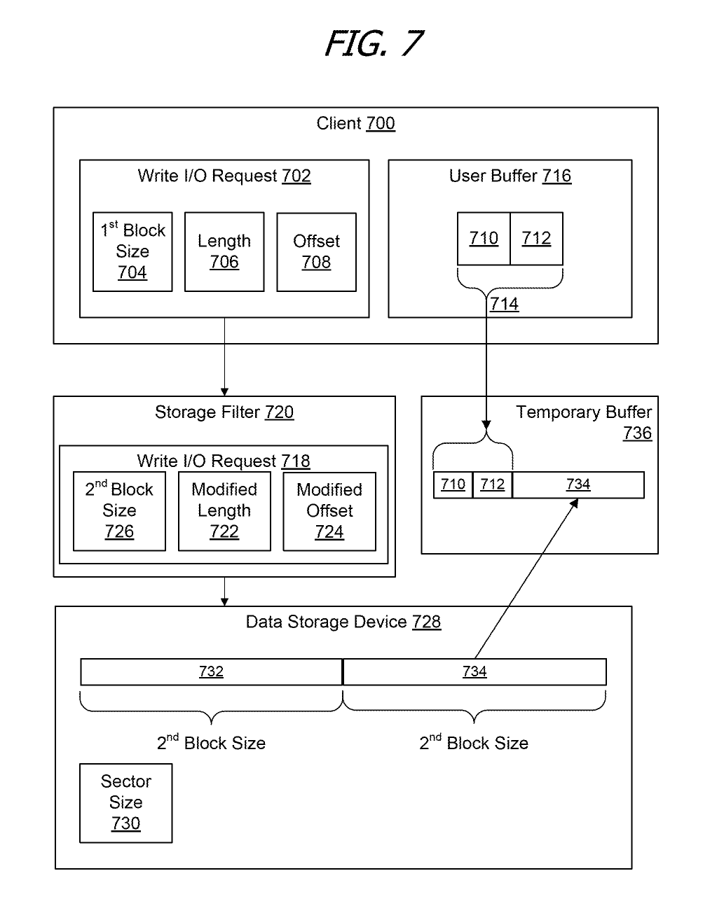

FIG. 7 is a block diagram illustrating a storage filter translating a write request for a smaller block size to a write request for a larger block size associated with a data storage device. Client 700 may be a virtual machine or a non-virtual machine client. The client 700 in this example issues a write IO request 702 conforming to a first block size 704. The first block size 704 of the write IO request 702 is a smaller block size than the block associated with a data storage device 728. The write IO request 702 optionally includes a length 706 and an offset 708 corresponding to the smaller block size 704.

The write IO request 702 is a request to write data to the data storage device 728. In this non-limiting example, the write IO request 702 is a request to write data in data blocks 710 and 712. Data blocks 710 and 712 are blocks of the smaller block size 704. The data blocks 710 and 712 form requested write data 714. The write data is data to be written to the data storage device 728. The write data is stored in the user buffer 716 in this example.

Storage filter 720 issues a modified write IO request 702 to form a new write IO request corresponding to the larger block size 726 of the underlying data storage device 728. In this example, the storage filter 720 generates a modified write IO request 702 to perform a read-modify-write operation to perform the block size conversion.

In this example, the first block size 704 of the original write IO request 702 is smaller than the second block size 726 of the data storage device 728. The modified write IO request 718 may be referred to as a small-to-large write IO request.

The modified write IO request 718 may include a modified length 722 and a modified offset 724. The modified length 722 and modified offset 724 may be utilized to locate the one or more data blocks of the larger block size 726 in the data storage device corresponding to the original write IO request 702.

The sector size 730 of the data storage device 728, in some examples, indicates the size of the sectors in which data is stored on the data storage device 728. In this example, the sector size 730 corresponds to the larger block size 726. The data blocks 732 and 734 are data blocks stored on the data storage device in sectors of the larger block size 726.

The modified write IO request 718 is processed to identify the one or more data blocks containing the portion of the block to be written. The selected data block 734 is copied into temporary buffer 736. In some examples, the data may be copied from a cache into the temporary buffer.

In other examples, a cache may not be available or the selected data block 734 may not be available in the cache. In these examples, the selected data block 734 is read from the data storage device 728 into the temporary buffer 736.

The selected data block 734 in the temporary buffer 736 is then modified. The data block is modified by writing data blocks 710 and 712 from the user buffer 716 into the selected data block 736 within the temporary buffer 716. In other words, the user buffer 716 data is written into the larger data block 734 within the temporary buffer 734 to form a modified data block. This modified data block of the larger block size 726 may then be written back into the data storage device 728 without data corruption.

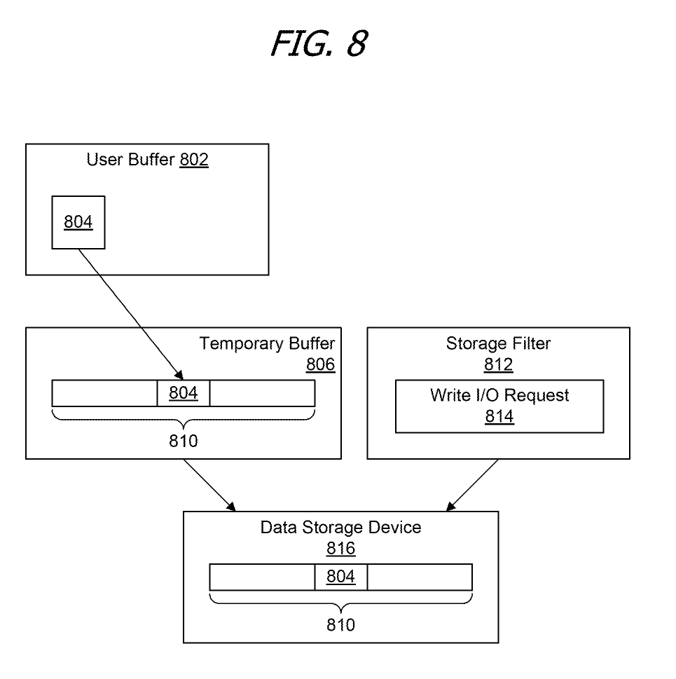

FIG. 8 is a block diagram illustrating writing data associated with a smaller block size to a data storage device having a larger block size in accordance with a set of commands generated by a storage filter. In this example, a small-to-large write IO request is processed to write data associated with a smaller block size to a data storage device associated with a larger data block size. The write data is stored in a user buffer 802. The write data 804 of a smaller block size than the block size of the data storage device 816.

The storage filter 812 generates the modified write IO request 814 to perform a read-modify-write operation to perform the block size conversion. The modified write IO request 814, in some examples, includes a set of one or more commands to carry out the read-modify-write operation. The set of one or more commands may include one or more SCSI command(s).

The data block 810 corresponding to the larger block size containing the portion of the sector to be written over is copied into a temporary buffer 806. The larger data block 810 is modified by writing the write data 804 into the larger data block 810 in the temporary buffer 806 to form a modified data block. In this example, the write data 804 is written into the middle of the larger data block 810. However, the write data 804 may be written in any appropriate portion of the larger data block 810.

This modified larger data block containing the write data block 804 is copied from the temporary buffer to the data storage device 816. When the modified data block 810 is completely written to the data storage device 816, the write operation is complete.

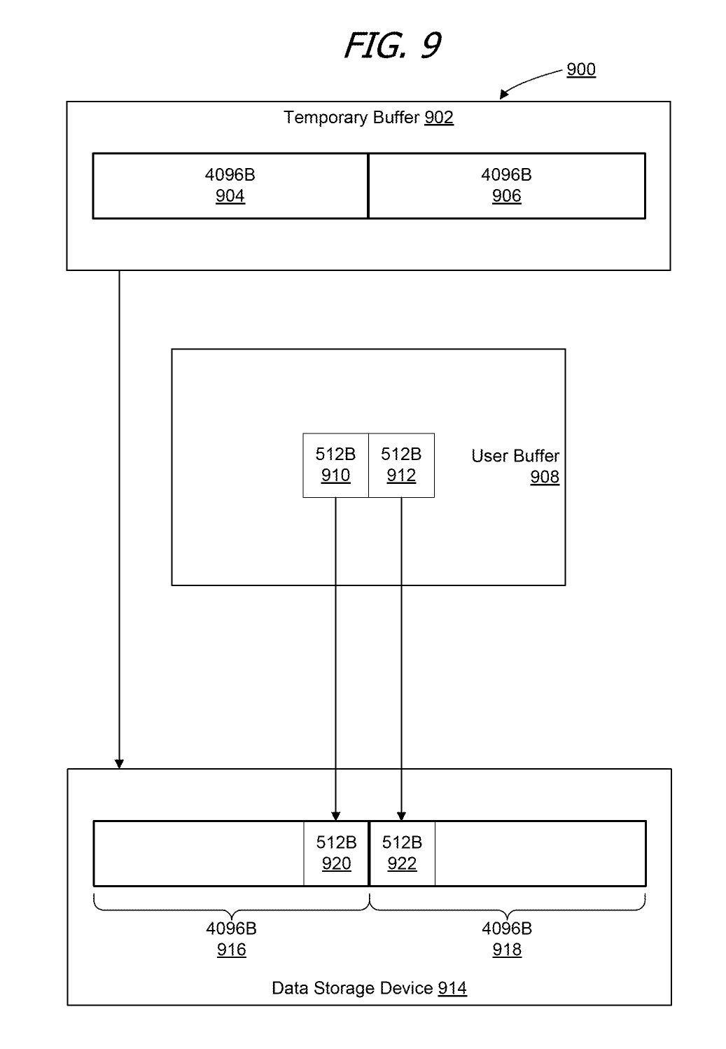

FIG. 9 is a block diagram illustrating writing 512 byte block size data to a data storage device associated with a 4096 byte block size. In this example, the storage filter issues a small-to-large write IO request to enable a write of 512 block data to a data storage device 914 associated with a 4096 sector size.

The larger 4096 byte block size data 904 and 906 associated with portions of the sectors in which data is to be written are copied into temporary buffer 902. In some examples, the filter server allocates a larger buffer to accommodate the larger data blocks, such as temporary buffer 902.

The write data in the smaller data blocks 910 and 912 may be written from the user buffer 908 to the temporary buffer 902 to form the modified, larger data blocks, as shown in FIG. 8 above. However, in other examples, the storage filter may issue a scatter-gather command to write the temporary buffer 902 data and user buffer 908 data with a single command rather than as a two-step process.

In this example, the scatter-gather command copies the larger data blocks 904 and 906 from the temporary buffer 902 and the smaller write data blocks 910 and 912 from the user buffer 908 to the data storage device 914 in a single step to the create the modified, larger data blocks 916 and 918 in the data storage device 914. The larger data blocks 916 and 918 are modified data blocks because they contain new data written to the data storage device 914.

The scatter-gather command enables the storage filter to write the data from two buffers at the same time using a single command. This scatter-gather optimization is more efficient and consumes fewer system resources than the two step process described in FIG. 7 and FIG. 8 above.

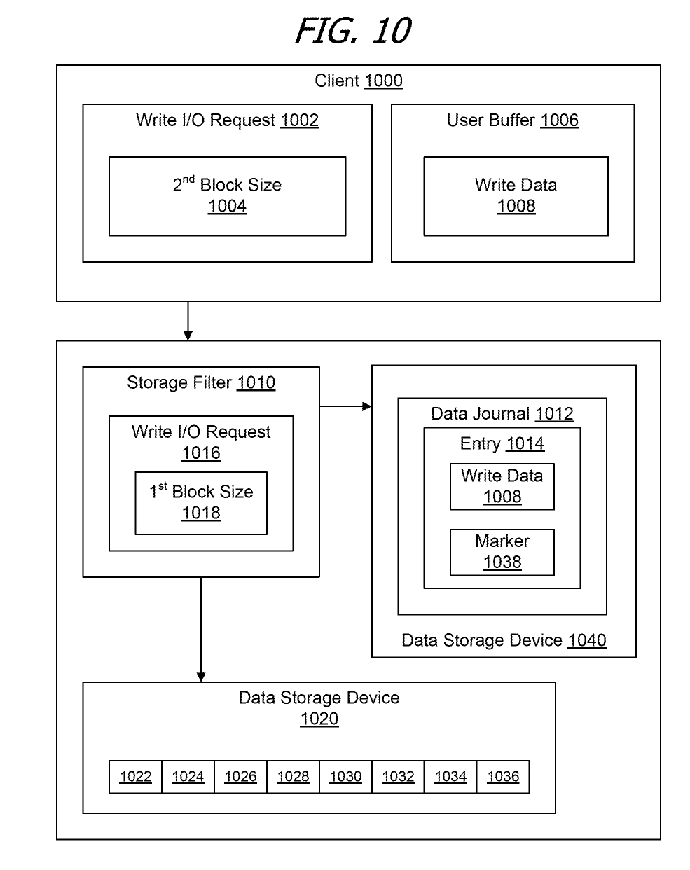

FIG. 10 is a block diagram illustrating writing data associated with a larger block size to a data storage device associated with a smaller block size. Client 1000 may be a virtual machine or a non-virtualized client. Client 1000 issues a write IO request 1002 associated with block size 1004. The data to be written is stored as write data 1008 in block size 1004 within user buffer 1006. The data storage device 1020 in this example stores data in a block size 1018 that is smaller than block size 1004 of the client 1000. In other words, the write IO request 1002 is a request to write data in a block size format that is larger than the block size of the data storage device 1020.

Storage filter 1010 issues a new write IO request corresponding to the smaller block size 1018 of the data storage device 1020. The new write IO request is a modified write request containing a set of write-related commands. The set of commands are executed to carry out the write operation on the data storage device 1020. This new write IO request may be referred to as a large-to-small write request.

In some examples, the storage filter 1010 writes all of the write data 1008 to a data journal 1012. A data journal 1012 is a persistent data structure for tracking progress of write operations to the data storage device 1020. The data entries in the data journal may be used for data recovery after failure. A failure may include, without limitation, a power failure, system crash, or any other event that prevents a write operation from completing. If the write operation fails prior to completion, the write data 1008 stored in the user buffer 1006, temporary buffer, cache, or any other volatile storage will be lost.

The data journal 1012 may be stored on the same data storage device as the data that is tracked by the data journal. For example, the data journal may be stored on the same disk onto which write data 1008 is being written.

However, in other examples, the data journal is stored on a different data storage device than the data that is being tracked. In this example, the data journal is stored on a disk or other storage device, such as an SSD, that is external or separate from the data storage device 1020 on which the write data 1008 is being written.

The storage filter 1010 creates an entry 1014 in the data journal 1012 corresponding to the current write operation associated with the original write IO request 1002 and/or modified write IO request 1016. The storage filter 1010 writes all of the write data 1008 to the data journal entry 1014. On determining that the data write to the journal is complete, the storage filter writes the write data 1008 to the data storage device 1020.

In this example, the write data 1008 is a 4096 byte block size. The data storage device 1020 is organized into 512 byte sectors. Therefore, the write data 1008 is written into the data storage device 1020 as eight 512 byte blocks instead of a single 4096 byte block.

On determining that write data 1008 has been written to the data storage device in its entirety, the storage filter updates the data journal to indicate the data write operation is complete. The storage filter 1010 may update the data journal 1012 to indicate all the write data 1008 has been completely written to the data storage device 1020 by writing a marker 1038 to the entry 1014 of the data journal 1012. The marker 1038 indicates the data write operation is complete. In this non-limiting example, the write operation is complete when all of data blocks 1022, 1024, 1026, 1028, 1030, 1032, 1034, and 1036 have been written successfully to the data storage device 1020.

In some examples, if a failure occurs prior to the storage filter 1010 creating the entry 1014 to the data journal, the write data 1008 in the user buffer is lost and the write operation is not performed. The data in the data storage device 1020 contains only “old data.” In other words, the data storage device 1020 does not contain any of the “new” write data 1008.

In other examples, if a failure occurs after the storage filter 1010 creates the entry 1014, but before writing the write data 1008 to the data journal 1012, the write data 1008 in the user buffer is lost. The write data 1008 is not written to the data storage device 1020 and the write operation is not performed.

In other examples, if the failure occurs after the write data 1008 is written to the data journal in its entirety, the storage filter 1010 checks the data journal 1012 after the failure. The data journal preserves the write data 1008. The lack of a marker 1038 indicates the write was not performed. The storage filter 1010 uses the write data 1008 in the data journal entry 1014 to recover the write data 1008 and complete the write operation. The storage filter 1010 re-initiates the data write to the data storage device 1020. When the write is complete, the storage filter 1010 writes the marker 1038 to the data journal 1012.

In still other examples, if a failure occurs after writing of the write data 1008 to the data storage device 1020 has begun but before all the write data 1008 is completely written to the data storage device 1020, the storage filter 1010 checks the data journal 1012 after the failure. The data journal preserves the write data 1008. The lack of a marker 1038 indicates the write was not performed. The data storage device 1020 contains the old data and not the new write data 1008. Therefore, the storage filter 1010 uses the write data 1008 in the data journal entry 1014 to recover the write data 1008 and complete the write operation. The storage filter 1008 re-initiates the data write to the data storage device 1020. When the write is complete, the storage filter 1010 writes the marker 1038 to the data journal 1012. This process ensures write atomicity and prevents partial or incomplete data writes from being made to the data storage device.

In yet other examples, if a failure occurs after the write data 1008 has completely been written to the data storage device 1020, the marker 1038 indicates the write operation was completed successfully. Therefore, the storage filter 1010 does not take any other action during recovery because the write operation was already complete. The data in the data storage device 1020 contains the new write data 1008.

Thus, the data journal enables efficient and accurate data recovery after failure. The data journal also ensures write atomicity. This write atomicity prevents data corruption and other issues which may arise if only part or a portion of new write data 1008 were written to the data storage device 1020. The data journal ensures accuracy of the data, enables recovery of lost write data after failure, and prevents partial writes from occurring.

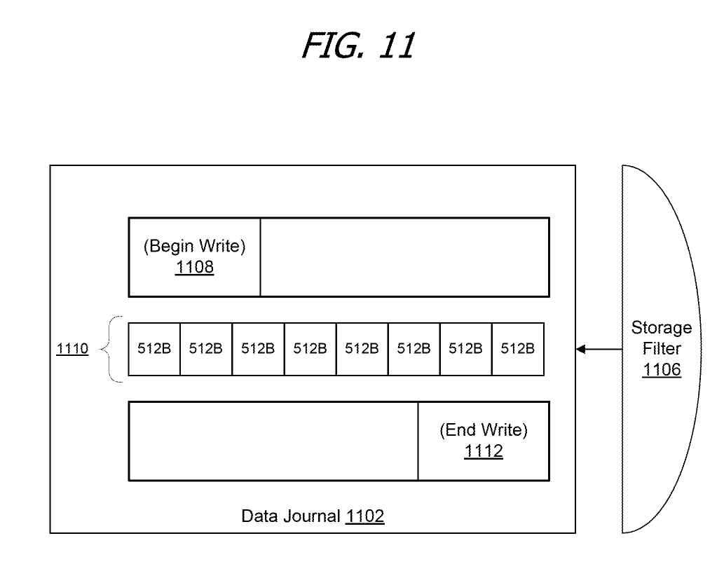

FIG. 11 is a block diagram illustrating writing 4096 byte block size data to a data storage device associated with a 512 byte block size by a storage filter using a data journal. In some examples, data journal 1102 maintains a record of write operations to the data storage device which have not yet begun, write operations that have begun but not yet completed, and completed write operations.

The storage filter 1106 creates an entry 1108 indicating a write operation has begun. The storage filter 1106 writes all of the write data to the data journal entry 1110. In other words, all of the new data to be written to the data storage device is first copied into the data journal 1102. In other words, the new data is written to the journal before the new data is written to the data storage device.

After copying the write data to the data journal 1102, the write data is copied to the appropriate sector(s) of the data storage device. When all write data 1008 has been completely written to the data storage device, the storage filter 1106 updates the data journal 1102 to indicate the write operation is complete 1112.

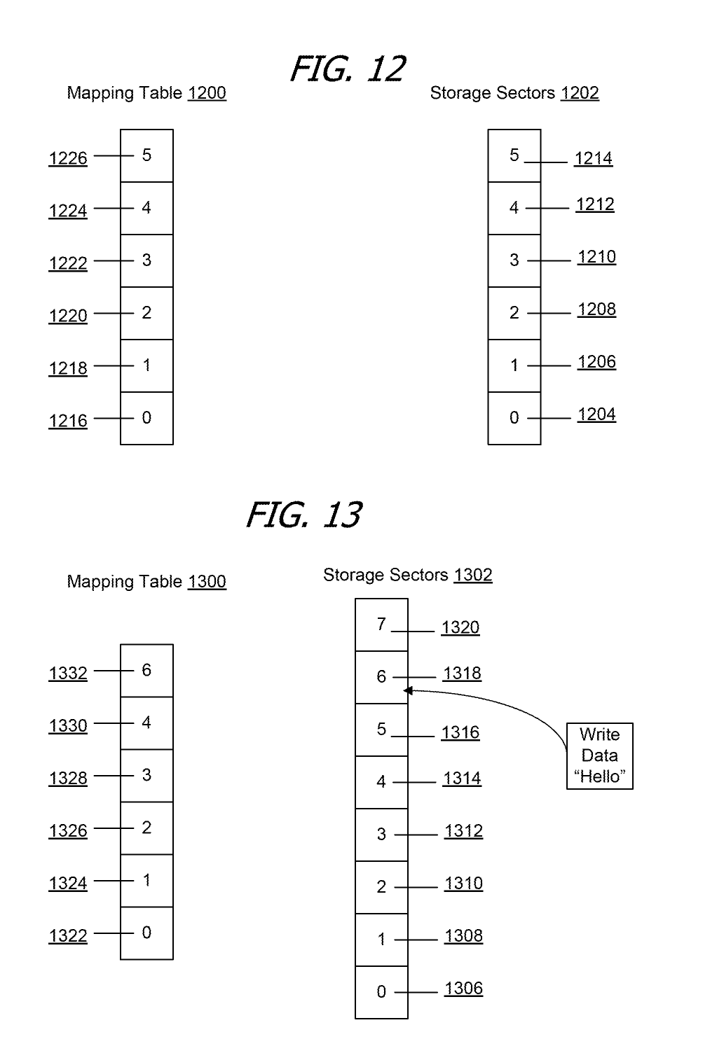

FIG. 12 is a mapping table utilized by a storage filter for converting write requests associated with a smaller byte block size to write requests associated with a larger byte block size. A mapping table 1200 is a persistent table for mapping used sectors containing data and “free” sectors of data storage that are available for writes. In other words, a free sector is a sector to which write data may be written.

The mapping table 1200 is created on the data storage device. When the mapping table is created, the mapping table 1200 sectors are mapped to the data sectors of the data storage device. Each time data is written to a sector, or a sector is made available or “free”, the mapping table is updated.

In this example, each sector in the mapping table maps to a corresponding data storage sector. The data storage device sectors 1202 include sector “0” 1204, sector “1” 1206, sector “2” 1208, sector “3” 1210, sector “4” 1212 and sector “5” 1214. Each of these sectors is mapped in mapping table 1200. In this example, the mapping table 1200 includes entries 1216, 1218, 1220, 1222, 1224, and 1226. However, a mapping table is not limited to the number of mapped sectors shown here. A mapping table may include any number of entries corresponding to any number of storage sectors.

In this example, mapping table 1200 sector “0” 1216 maps to storage sector “0” 1204. Mapping table 1200 sector “1” maps to storage sector “1” 1206, and so forth. In response to receiving a read request, the storage filter checks mapping table 1200 to identify the sector containing the desired read data. Likewise, on receiving a write request, the storage filter may check the mapping table 1200 to identify one or more free sectors that are available to receive the write data.

For example, if a client sends a write request to write data “hello” to sector five (5), the storage filter checks the mapping table 1200 for a free sector on which to copy the write data. In this example, sectors “0” through “5” already contain data. The mapping table indicates sectors “6” and “7” are free. In some examples, the storage filter selects the free sector that is closest to the selected sector identified in the write request. In this example, sector “6” is closest to sector “5”. Therefore, the storage filter identifies sector “6” for the write. After the write data “hello” is successfully written to sector “6”, the mapping table 1200 is updated to indicate that sector “5” is free and sector “6” now contains the “hello” data.

FIG. 13 is an updated mapping table utilized by a storage filter. Mapping table 1300 is a persistent table mapping free physical data storage sectors and storage sectors 1302 containing data. The storage sectors 1302 in this example include sector “0” 1306, sector “1” 1308, sector “2” 1310, sector “3” 1312, sector “4” 1314, sector “5” 1316, sector “6” 1318, and sector “7” 1320.

The mapping table 1300 includes entries for sector “0” 1322, sector “1” 1324, sector “2” 1326, sector “3” 1328, sector “4” 1330, and sector “6” 1332. Sector “5” is not included because sector “5” is a free sector available for new writes.

In this example, mapping table 1300 is updated to indicate that sector “6” on the physical data storage device contains data “hello” corresponding to sector “5”. If a client sends a read request to read data associated with sector “5”, the mapping table 1300 indicates that the data is actually stored in sector “6”. If a write request is received to write data to sector “6”, the mapping table indicates that sector “5” or sector “7” are available for the write. The mapping table 1300 enables efficient read and writes of data stored on a data storage device.

FIG. 14 is a flowchart of a process for converting read requests associated with a smaller block size to a larger block size by a storage filter. The process shown in FIG. 14 may be performed by a storage filter associated with a hypervisor or any computing device. Further, execution of the operations illustrated in FIG. 4 is not limited to a VM environment, but is applicable to any non-virtualized system. Also, one or more computer-readable storage media storing computer-executable instructions may execute to cause a processor to implement the transactions by performing the operations illustrated in FIG. 14.

A storage filter receives an IO request associated with a block size that is different than a block size of a data storage device at 1402. If the IO request is not a read request at 1404, the process terminates thereafter.

If the IO request is a read request at 1404, the storage filter determines is the read data is available in cache at 1406. If the read data is available in cache, the cached read data is retrieved from the cache at 1408. The process terminates thereafter.

If the read data is not available in a cache, the storage filter determines whether the read request is a small-to-large read request at 1410. A small-to-large read request is a request associated with a data block size that is smaller than the data block size of the data storage device. If the request is not a small-to-large request, it is a large-to-small read request. A large-to-small request is a request associated with a block size that is larger than a block size of the data storage device.

If this is not a small-to-large request at 1410, the storage filter generates a new read request associated with the smaller block size of the data storage device based on a multiple of the smaller block size to the larger block size of the original read request at 1412. The storage filter reads the range of smaller data blocks corresponding to the read request from the data storage device into the user buffer at 1414. This completes the read request and the process terminates thereafter.

If the request is a small-to-large request at 1410, the storage filter generates a new read request associated with the larger block size of the data storage device at 1416. The new read request may be referred to as a small-to-large IO read request or a modified read request. The storage filter reads at least one block size of the larger block size containing the requested smaller block size read data into a temporary buffer at 1418. The storage filter copies only the requested read data in the smaller block sizes from the temporary buffer to the user buffer at 1420. The unneeded or unused portions of the larger data block in the temporary buffer that do not contain requested read data are not copied out of the temporary buffer. The unneeded portion of the data in the temporary buffer may be discarded. The process terminates thereafter.

FIG. 15 is a flowchart of a process for converting write requests associated with a smaller block size to a larger block size by a storage filter. The process shown in FIG. 15 may be performed by a storage filter associated with a hypervisor or any computing device. Further, execution of the operations illustrated in FIG. 4 is not limited to a VM environment, but is applicable to any non-virtualized system. Also, one or more computer-readable storage media storing computer-executable instructions may execute to cause a processor to implement the transactions by performing the operations illustrated in FIG. 15.

The storage filter receives a first write request associated with a block size that is smaller than a block size of a data storage device at 1502. The storage filter generates a second write request corresponding to the larger block size at 1504. The second write request may be referred to as a modified IO request or a modified write request.

If a range of one or more data blocks of the larger block size required for the write operation is available in cache 1506, the range of data blocks is retrieved from cache at 1508. If the required larger block size data is not cached, the range of data blocks of the larger block size is read from the data storage device to the temporary buffer at 1510. The storage filter copies the write data of the smaller block size to the temporary buffer to form a modified data block of the larger block size at 1512. The storage filter issues a third write request to write the modified range of data blocks of the larger block size to the data storage device at 1514. The process terminates thereafter.

FIG. 16 is a flowchart of a process for converting write requests associated with a larger block size to a smaller block size associated with a data storage device, by a storage filter. The process shown in FIG. 16 may be performed by a storage filter associated with a hypervisor or any computing device. Further, execution of the operations illustrated in FIG. 4 is not limited to a VM environment, but is applicable to any non-virtualized system. Also, one or more computer-readable storage media storing computer-executable instructions may execute to cause a processor to implement the transactions by performing the operations illustrated in FIG. 16.

The storage filter receives a write request associated with a larger block size than a block size of the data storage at 1602. The storage filter generates a new write request corresponding to the larger block size at 1604. The new write request may be referred to as a modified write request or a large-to-small write request.

The storage filter makes a determination as to whether a mapping table is available at 1606. If a mapping table is available, the storage filter checks the mapping table for free sectors for the write operation at 1608. The storage filter copies the write data to the set of one or more free sectors of the data storage device at 1610. The storage filter updates the mapping table to identify the sectors containing the newly written data and indicate the sectors are no longer free at 1612. The write operation is complete and the process terminates thereafter.

If a mapping table is not available at 1606, the storage filter writes all requested write data from the user buffer into a data journal at 1614. If all the write data has successfully been copied to the data journal at 1616, the storage filter copies all write data from the data journal to the data storage device at 1618. If the write data is completely written to the data storage device at 1620, the storage filter updates the data journal to indicate the write operation completed successfully at 1622. The process terminates thereafter.

FIG. 17 is a block diagram of an example host computing device 1701. Host computing device 1701 includes a processor 1702 for executing instructions. In some examples, executable instructions are stored in a memory 1704. Memory 1704 is any device allowing information, such as executable instructions and/or other data, to be stored and retrieved. For example, memory 1704 may include one or more random access memory (RAM) modules, flash memory modules, hard disks, solid state disks, and/or optical disks.

Host computing device 1701 may include a user interface device 1710 for receiving data from a user 1708 and/or for presenting data to user 1708. User 1708 may interact indirectly with host computing device 1701 via another computing device such as VMware's vCenter Server or other management device. User interface device 1710 may include, for example, a keyboard, a pointing device, a mouse, a stylus, a touch sensitive panel (e.g., a touch pad or a touch screen), a gyroscope, an accelerometer, a position detector, and/or an audio input device. In some examples, user interface device 1710 operates to receive data from user 1708, while another device (e.g., a presentation device) operates to present data to user 1708. In other examples, user interface device 1710 has a single component, such as a touch screen, that functions to both output data to user 1708 and receive data from user 1708. In such examples, user interface device 1710 operates as a presentation device for presenting information to user 1708. In such examples, user interface device 1710 represents any component capable of conveying information to user 1708. For example, user interface device 1710 may include, without limitation, a display device (e.g., a liquid crystal display (LCD), organic light emitting diode (OLED) display, or “electronic ink” display) and/or an audio output device (e.g., a speaker or headphones). In some examples, user interface device 1710 includes an output adapter, such as a video adapter and/or an audio adapter. An output adapter is operatively coupled to processor 1702 and configured to be operatively coupled to an output device, such as a display device or an audio output device.

Host computing device 1701 also includes a network communication interface 1712, which enables host computing device 1701 to communicate with a remote device (e.g., another computing device) via a communication medium, such as a wired or wireless packet network. For example, host computing device 1701 may transmit and/or receive data via network communication interface 1712. User interface device 1710 and/or network communication interface 1712 may be referred to collectively as an input interface and may be configured to receive information from user 1708.

Host computing device 1701 further includes a storage interface 1716 that enables host computing device 1701 to communicate with one or more data stores, which store virtual disk images, software applications, and/or any other data suitable for use with the methods described herein. In example examples, storage interface 1716 couples host computing device 1701 to a storage area network (SAN) (e.g., a Fibre Channel network) and/or to a network-attached storage (NAS) system (e.g., via a packet network). The storage interface 1716 may be integrated with network communication interface 1712.

FIG. 18 depicts a block diagram of virtual machines 1835₁, 1835₂ . . . 1835_{N} that are instantiated on host computing device 1701. Host computing device 1701 includes a hardware platform 1805, such as an x86 architecture platform. Hardware platform 1805 may include processor 1702, memory 1704, network communication interface 1712, user interface device 1710, and other input/output (I/O) devices, such as a presentation device 1706 (shown in FIG. 17). A virtualization software layer is installed on top of hardware platform 1805. The virtualization software layer in this example includes a hypervisor 1810,

The virtualization software layer supports a virtual machine execution space 1830 within which multiple virtual machines (VMs 1835₁-1835_{N}) may be concurrently instantiated and executed. Hypervisor 1810 includes a device driver layer 1815, and maps physical resources of hardware platform 1805 (e.g., processor 1702, memory 1704, network communication interface 1712, and/or user interface device 1710) to “virtual” resources of each of VMs 1835₁-1835_{N} such that each of VMs 1835₁-1835_{N} has its own virtual hardware platform (e.g., a corresponding one of virtual hardware platforms 1840₁-1840_{N}), each virtual hardware platform having its own emulated hardware (such as a processor 1845, a memory 1850, a network communication interface 1855, a user interface device 1860 and other emulated I/O devices in VM 1835₁). Hypervisor 1810 may manage (e.g., monitor, initiate, and/or terminate) execution of VMs 1835₁-1835_{N} according to policies associated with hypervisor 1810, such as a policy specifying that VMs 1835₁-1835_{N} are to be automatically restarted upon unexpected termination and/or upon initialization of hypervisor 1810. In addition, or alternatively, hypervisor 1810 may manage execution VMs 1835₁-1835_{N} based on requests received from a device other than host computing device 1701. For example, hypervisor 1810 may receive an execution instruction specifying the initiation of execution of first VM 1835₁ from a management device via network communication interface 1712 and execute the execution instruction to initiate execution of first VM 1835₁.

In some examples, memory 1850 in first virtual hardware platform 1840₁ includes a virtual disk that is associated with or “mapped to” one or more virtual disk images stored on a disk (e.g., a hard disk or solid state disk) of host computing device 1701. The virtual disk image represents a file system (e.g., a hierarchy of directories and files) used by first VM 1835₁ in a single file or in a plurality of files, each of which includes a portion of the file system. In addition, or alternatively, virtual disk images may be stored on one or more remote computing devices, such as in a storage area network (SAN) configuration. In such examples, any quantity of virtual disk images may be stored by the remote computing devices.

Device driver layer 1815 includes, for example, a communication interface driver 1820 that interacts with network communication interface 1712 to receive and transmit data from, for example, a local area network (LAN) connected to host computing device 1701. Communication interface driver 1820 also includes a virtual bridge 1825 that simulates the broadcasting of data packets in a physical network received from one communication interface (e.g., network communication interface 1712) to other communication interfaces (e.g., the virtual communication interfaces of VMs 1835₁-1835_{N}). Each virtual communication interface for each VM 1835₁-1835_{N}, such as network communication interface 1855 for first VM 1835₁, may be assigned a unique virtual Media Access Control (MAC) address that enables virtual bridge 1825 to simulate the forwarding of incoming data packets from network communication interface 1712. In an example, network communication interface 1712 is an Ethernet adapter that is configured in “promiscuous mode” such that all Ethernet packets that it receives (rather than just Ethernet packets addressed to its own physical MAC address) are passed to virtual bridge 1825, which, in turn, is able to further forward the Ethernet packets to VMs 1835₁-1835_{N}. This configuration enables an Ethernet packet that has a virtual MAC address as its destination address to properly reach the VM in host computing device 1701 with a virtual communication interface that corresponds to such virtual MAC address.

Virtual hardware platform 1840₁ may function as an equivalent of a standard x86 hardware architecture such that any x86-compatible desktop operating system (e.g., Microsoft WINDOWS brand operating system, LINUX brand operating system, SOLARIS brand operating system, NETWARE, or FREEBSD) may be installed as guest operating system (OS) 1865 in order to execute applications 1870 for an instantiated VM, such as first VM 1835₁. Virtual hardware platforms 1840₁-1840_{N} may be considered to be part of virtual machine monitors (VMM) 1875₁-1875_{N} that implement virtual system support to coordinate operations between hypervisor 1810 and corresponding VMs 1835₁-1835_{N}. Those with ordinary skill in the art will recognize that the various terms, layers, and categorizations used to describe the virtualization components in FIG. 18 may be referred to differently without departing from their functionality or the spirit or scope of the disclosure. For example, virtual hardware platforms 1840₁-1840_{N} may also be considered to be separate from VMMs 1875₁-1875_{N}, and VMMs 1875₁-1875_{N} may be considered to be separate from hypervisor 1810. One example of hypervisor 1810 that may be used in an example of the disclosure is included as a component in VMware's ESX brand software, which is commercially available from VMware, Inc.

Certain examples described herein involve a hardware abstraction layer on top of a host computer (e.g., server). The hardware abstraction layer allows multiple containers to share the hardware resource. These containers, isolated from each other, have at least a user application running therein. The hardware abstraction layer thus provides benefits of resource isolation and allocation among the containers. In the foregoing examples, VMs are used as an example for the containers and hypervisors as an example for the hardware abstraction layer. Each VM generally includes a guest operating system in which at least one application runs. It should be noted that these examples may also apply to other examples of containers, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources may be isolated, services restricted, and processes provisioned to have a private view of the operating system with their own process ID space, file system structure, and network interfaces. Multiple containers may share the same kernel, but each container may be constrained to only use a defined amount of resources such as CPU, memory and I/O.

### Exemplary Operating Environment

The operations described herein may be performed by a computer or computing device. The computing devices communicate with each other through an exchange of messages and/or stored data. Communication may occur using any protocol or mechanism over any wired or wireless connection. A computing device may transmit a message as a broadcast message (e.g., to an entire network and/or data bus), a multicast message (e.g., addressed to a plurality of other computing devices), and/or as a plurality of unicast messages, each of which is addressed to an individual computing device. Further, in some examples, messages are transmitted using a network protocol that does not guarantee delivery, such as User Datagram Protocol (UDP). Accordingly, when transmitting a message, a computing device may transmit multiple copies of the message, enabling the computing device to reduce the risk of non-delivery.

By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible, non-transitory, and are mutually exclusive to communication media. In some examples, computer storage media are implemented in hardware. Exemplary computer storage media include hard disks, flash memory drives, digital versatile discs (DVDs), compact discs (CDs), floppy disks, tape cassettes, and other solid-state memory. In contrast, communication media typically embody computer readable instructions, data structures, program modules, or other data in a modulated data signal such as a carrier wave or other transport mechanism, and include any information delivery media.

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special-purpose computing device when programmed to execute the instructions described herein.

The examples illustrated and described herein as well as examples not specifically described herein but within the scope of aspects of the disclosure constitute exemplary means for providing input and output request block size compatibility. For example, the elements in FIGS. 1-13, 17, and 18, and the operations illustrated in FIGS. 14-16, constitute:

exemplary means for receiving an IO request associated with a first block size from a client

exemplary means for converting the IO request associated with the first block size to an IO request associated with the second block size by a storage filter

exemplary means for, on determining the IO request is a read request and the first block size is smaller than the second block size, generating a small-to-large read IO request, reading at least one data block of the second block size from the data storage device into a temporary buffer, and copying at least one requested data block of the first block size from the temporary buffer into a user buffer

exemplary means for, on determining the IO request is the read request and the first block size is larger than the second block size, generating a large-to-small read IO request, and reading a range of data blocks of the second block size from the data storage device into the user buffer

exemplary means for, on determining the IO request is a write request and the first block size is smaller than the second block size, the write request having write data associated therewith and stored in the user buffer, generating a small-to-large write IO request, reading at least one data block of the second block size from the data storage device into a temporary buffer, writing the write data from the user buffer to the temporary buffer to form at least one modified data block of the second block size in the temporary buffer, and writing the at least one modified data block from the temporary buffer to the data storage device

exemplary means for, on determining the IO request is the write request and the first block size is larger than the second block size, generating a large-to-small write IO request, and writing the write request from the user buffer to the data storage device using a data journal.

At least a portion of the functionality of the various elements illustrated in the figures may be performed by other elements in the figures, or an entity (e.g., processor, web service, server, application program, computing device, etc.) not shown in the figures.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

We claim:

1. A method comprising:
receiving an input/output (IO) request associated with a first block size from a client, the first block size being a different block size than a second block size associated with a data storage device; and
converting the IO request associated with the first block size to a modified IO request associated with the second block size by a storage filter, converting the IO request to the modified IO request further comprising:
on determining the IO request is a read request and the first block size is a smaller block size than the second block size, generating a small-to-large read IO request, reading at least one data block of the second block size from the data storage device into a temporary buffer, and copying at least one requested data block of the first block size from the temporary buffer into a user buffer;
on determining the IO request is the read request and the first block size is a larger block size than the second block size, generating a large-to-small read IO request, and reading a range of data blocks of the second block size from the data storage device into the user buffer;
on determining the IO request is a write request and the first block size is the smaller block size than the second block size, the write request having write data associated therewith and stored in the user buffer, generating a small-to-large write IO request, reading at least one data block of the second block size from the data storage device into a temporary buffer, writing the write data from the user buffer to the temporary buffer to form at least one modified data block of the second block size in the temporary buffer, and writing the at least one modified data block from the temporary buffer to the data storage device; and
on determining the IO request is the write request and the first block size is the larger block size than the second block size, generating a large-to-small write IO request, and writing write data associated with the write request from the user buffer to the data storage device using a data journal.

2. The method of claim 1, wherein writing the write data associated with the write request from the user buffer to the data storage device using a data journal further comprises:
writing the write data to an entry in the data journal;
on determining the write data is completely written to the data journal entry, writing the write data from the data journal entry to the data storage device; and
on determining the write data is completely written to the data storage device, updating the data journal to indicate the write operation is complete.

3. The method of claim 1, wherein the modified IO request comprises a modified length and a modified offset, and wherein generating the modified IO request further comprises:
calculating the modified length and the modified offset based on a multiple of the first block size to the second block size.

4. The method of claim 1, further comprising:
processing the large-to-small write IO request, wherein processing the modified large-to-small write request further comprises:
identifying a set of free sectors on the data storage device using a mapping table;
writing the write data to the set of free sectors; and
updating the mapping table.

5. The method of claim 1, further comprising:
receiving the IO request from a virtual machine, wherein the storage filter is implemented on a hypervisor associated with the virtual machine.

6. The method of claim 1 wherein the data storage device is a first data storage device and further comprising:
creating the data journal on a second data storage device that is external to the first data storage device.

7. The method of claim 1 further comprising:
processing the small-to-large read IO request, wherein processing the small-to-large read IO request further comprises:
generating a scatter-gather command to read at least one data block of the larger block size from the data storage device into a temporary buffer and copy the at least one requested data block of the smaller block size into the user buffer using a single command.

8. The method of claim 1 further comprising:
processing the small-to-large write request, wherein processing the small-to-large write request further comprises generating a scatter-gather command to write the write data from the user buffer and the at least one data block from the temporary buffer to the data storage device to form the at least one modified data block using a single command.

9. One or more computer-readable storage media including computer-executable software instructions that, when executed, cause at least one processor to:
convert, by a storage filter, an IO write request associated with a first block size to a large-to-small write request associated with a second block size, the first block size being larger than the second block size; and
write requested write data associated with the IO write request from a user buffer to an entry in a data journal;
on determining the requested write data is written to the data journal entry in its entirety, copy the requested write data from the data journal to a data storage device associated with the second block size; and
on determining the requested write data is completely written to the data storage device, update the data journal to indicate the write operation is complete.

10. The computer storage media of claim 9, wherein the IO write request is received from a virtual machine.

11. The computer storage media of claim 9, wherein the storage filter is implemented by a hypervisor.

12. The computer storage media of claim 9, wherein the computer-executable instructions further cause the processor to:
check, by the storage filter, the data journal upon initial access of the data storage device;
on determining a write did not complete prior to a failure, recover the requested write data from the data journal and copy the requested write data from the data journal to the data storage device; and
on determining the requested write data is completely written to the data storage device, update the data journal to indicate the write operation is complete.

13. The computer storage media of claim 9, wherein the computer-executable instructions cause the processor to:
identify a set of free sectors on the data storage device using a mapping table;
write the requested write data to the set of free sectors; and
update the mapping table.

14. A system for providing input and output request block size compatibility, said system comprising:
at least one processor;
a data storage device associated with a first block size, the data storage device comprising a mapping table; and
a storage filter comprising computer executable code which, upon execution, causes the at least one processor to:
translate an input/output (IO) request associated with a second block size into a modified IO request corresponding to the second block size of the data storage device, the first block size being a different block size than a second block size; and
process the modified IO request, wherein processing the modified IO request wherein the computer executable code, when executed, further causes the at least one processor to:
calculate a modified offset and modified length based on a multiple of the first block size to the second block size on determining the IO request is a read request, read at least one data block of the first block size corresponding to the modified offset and modified length from the data storage device into a temporary buffer, and copy at least one requested data block of the second block size from the temporary buffer into a user buffer, the at least one requested data block comprises requested read data identified in the IO request; and
on determining the IO request is a write request, identify a set of free sectors of the data storage device using the mapping table, write requested write data associated with the write request into the set of free sectors, and update the mapping table.

15. The system of claim 14, wherein the computer executable code, upon execution, further causes the at least one processor to:
check a cache for the requested read data;
on determining the requested read data is available in the cache, retrieving the requested read data from the cache; and
on determining the requested read data is unavailable in the cache, retrieving the requested read data from the data storage device.

16. The system of claim 14, wherein the first block size is a 512 byte block size and wherein the second block size is a 4096 block size.

17. The system of claim 14, wherein the first block size is a 4096 byte block size, and wherein the second block size is a 512 byte block size.

18. The system of claim 14, further comprising a data journal, wherein the computer executable code, upon execution, further causes the at least one processor to:
write the requested write data associated with the IO write request from the user buffer to an entry in the data journal;
on determining the requested write data is written to the data journal entry in its entirety, copy the requested write data from the data journal to the data storage device; and
on determining the requested write data is completely written to the data storage device, update the data journal to indicate the write operation is complete.

19. The system of claim 18, wherein the computer executable code, upon execution, further causes the at least one processor to:
check the data journal upon initial access of the data storage device;
on determining a write did not complete prior to a failure, recover the requested write data from the data journal and copy the requested write data from the data journal to the data storage device; and
on determining the requested write data is completely written to the data storage device, update the data journal to indicate the write operation is complete.

20. The system of claim 19, wherein the data storage device is a first data storage device, and further comprising a second data storage device, the second data storage device storing the data journal.
